(19) United States
(12) Patent Application Publication
(10) Pub. No.: US 2018/0290296 A1
(43) Pub. Date: Oct. 11, 2018

(54) MANIPULATOR SYSTEM, CONTROLLER AND COMPUTER-READABLE STORAGE MEDIUM

(71) Applicant: OLYMPUS CORPORATION, Tokyo (JP)

(72) Inventor: Kyohei KURIHARA, Tokyo (JP)

(73) Assignee: OLYMPUS CORPORATION, Tokyo (JP)

(21) Appl. No.: 16/007,042

(22) Filed: Jun. 13, 2018

Related U.S. Application Data
(63) Continuation of application No. PCT/JP2015/085026, filed on Dec. 15, 2015.

(51) Int. Cl. B25J 9/12; B25J 9/16; H02P 7/18

(52) U.S. Cl. CPC B25J 9/126; H02P 6/16; H02P 7/18; B25J 9/1694

(57) ABSTRACT

A manipulator system of the present invention includes a manipulator driven by a motor, an operating part for generating an operation input for operating the manipulator, and a controller for controlling the motor. The controller controls for receiving a first current and a first voltage of the motor, for calculating a first resistance value of the motor on the basis of the first current and the first voltage, for controlling the motor to rotate thereof under a predetermined angle, for receiving a second current and a second voltage of the motor after rotating the motor, for calculating a second resistance value of the motor based on the second current and the second voltage, for adopting the larger one of the first resistance value and the second resistance value as a calculated resistance value, and for controlling the motor based on the operation input and the calculated resistance value.

### CROSS-REFERENCE TO RELATED APPLICATIONS

This is a continuation of International Application PCT/JP2015/085026, with an international filing date of Dec. 15, 2015, which is hereby incorporated by reference herein in its entirety.

### Technical Field

The present invention relates to a manipulator system and a method for controlling the same.

### Background Art

In a known method, the current flowing through a motor is detected, the detected current value is corrected on the basis of the rotation speed, and the resistance value of the coil of the motor is calculated on the basis of the corrected current value and a voltage instruction value (for example, see Japanese Unexamined Patent Application, Publication No. 2014-11861).

### Summary of Invention

An object of the present invention is to provide a manipulator system in which a manipulator can be accurately operated by compensating for parameter changes caused by a temperature change in more detail, and a method for controlling the same.

An aspect of the present invention is a manipulator system including: a manipulator configured to be driven by a motor; an operating part configured to generate an operation input for operating the manipulator; a controller configured to control the motor. The controller includes one or more processors. The one or more processors is configured to receive a first current of the motor, receive a first voltage of the motor, calculate a first resistance value of the motor on the basis of the first current and the first voltage, control the motor so as to rotate thereof under a predetermined angle, receive a second current of the motor after rotating the motor, receive a second voltage of the motor after rotating the motor, calculate a second resistance value of the motor on the basis of the second current and the second voltage, adopt the larger one of the first resistance value and the second resistance value as a calculated resistance value, and control the motor on the basis of the operation input and the calculated resistance value.

### BRIEF DESCRIPTION OF DRAWINGS

FIG. 1 shows the overall configuration of a manipulator system according to an embodiment of the present invention.

FIG. 2 is a flowchart showing a method for controlling the manipulator system in FIG. 1.

### Description of Embodiments

A manipulator system 1 and a method for controlling the same according to an embodiment of the present invention will be described below with reference to the drawings.

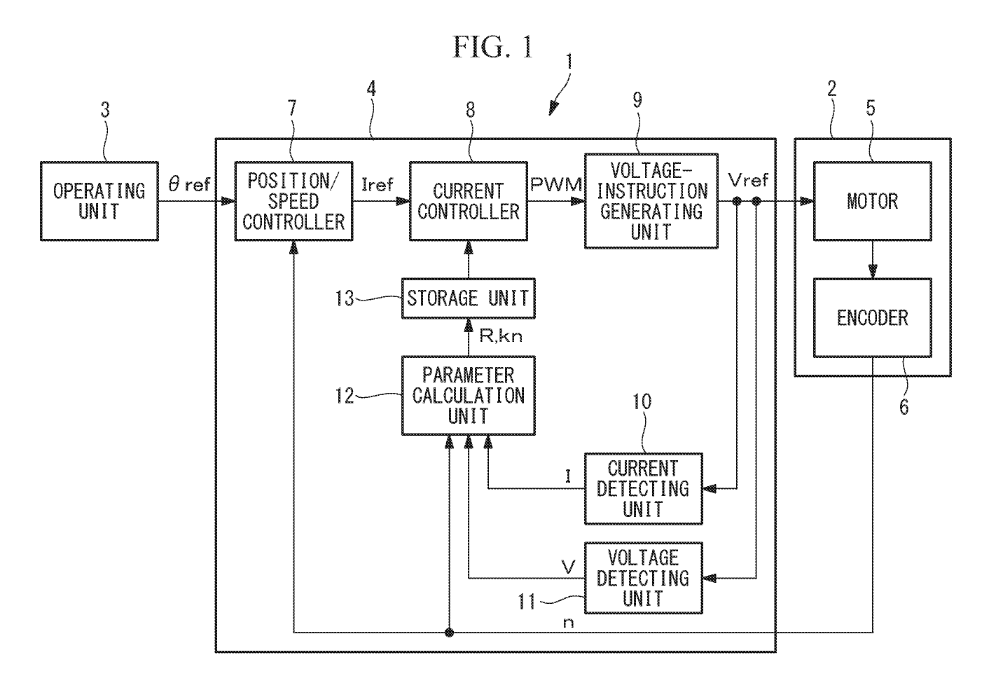

As shown in FIG. 1, the manipulator system 1 according to this embodiment includes a medical manipulator 2 to be inserted into the body to treat an affected area, an operating part 3 operated by an operator, and a controller 4 for controlling the manipulator 2 on the basis of the operation input entered via the operating part 3.

The manipulator 2 is of an electric type driven by a motor 5, and, when the motor 5 is rotated on the basis of a voltage instruction from the controller 4, the manipulator 2 is moved to a desired position. The manipulator 2 has an encoder (position detector) 6 that detects the rotation angle position of the motor 5.

In this embodiment, the motor 5 is a brushed DC motor.

The operating part 3 inputs a target rotation angle position θref of the motor 5 of the manipulator 2 through an operation input, which is represented by, for example, the amount of movement of a handle (not shown) operated by the operator.

The controller 4 includes a position/speed controller 7 that generates a target current instruction Iref on the basis of the difference between the target rotation angle position θref entered via the operating part 3 and the rotation angle position n of the motor 5 detected by the encoder 6. The controller 4 also includes a current controller 8 that outputs a voltage control signal (PWM control signal) corresponding to the target current instruction Iref generated by the position/speed controller 7. The controller 4 also includes a voltage-instruction generator 9 that generates a voltage instruction Vref to be entered into the motor 5 in response to the voltage control signal output by the current controller 8. The controller 4 also includes a current detector 10 that detects a current I flowing through the motor 5 from the voltage instruction Vref generated by the voltage-instruction generator 9, and a voltage detector 11 that detects a voltage V applied to the motor 5.

The controller 4 also includes: a parameter calculator 12 that calculates the resistance value R and the rotational speed constant kn of the motor 5 on the basis of the rotation angle position n detected by the encoder 6, the current I detected by the current detector 10, and the voltage V detected by the voltage detector 11. The controller 4 also includes a storage 13 that stores the resistance value R and the rotational speed constant kn calculated by the parameter calculator 12.

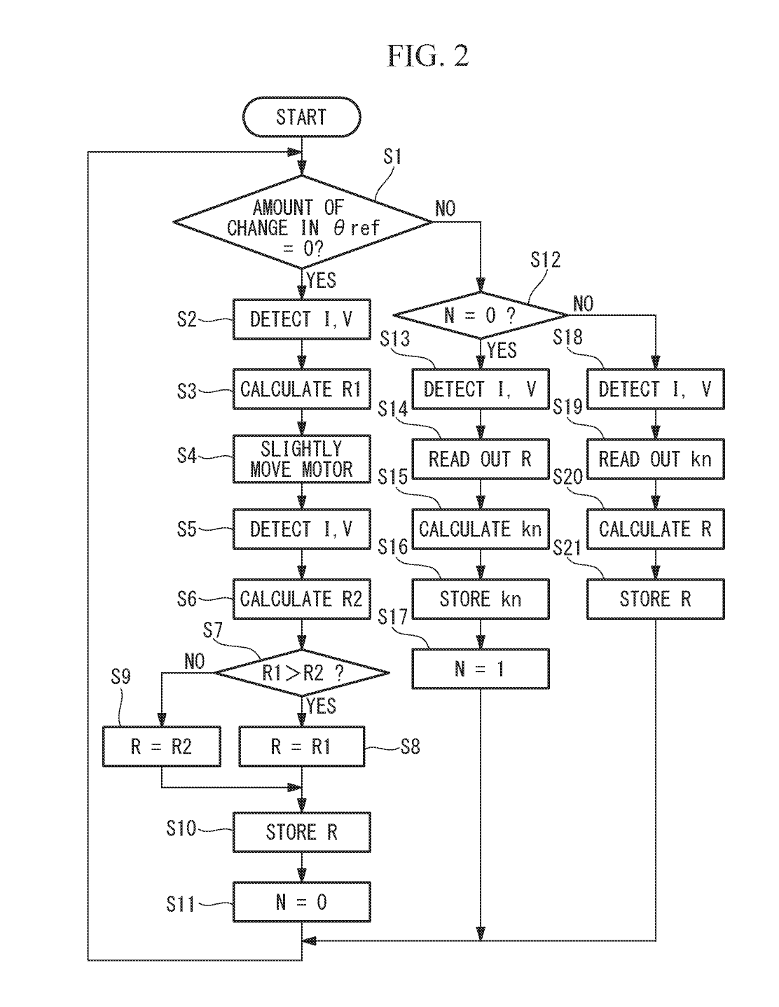

As shown in FIG. 2, the parameter calculator 12 determines if there is a change in the target rotation angle position entered via the operating part 3 (step S1). When there is no change in the target rotation angle position, a voltage that is not enough to rotate the motor 5 is applied to the motor 5, and the current and voltage to be supplied to the motor 5 are detected (step S2). Then, from the current and the voltage detected at this time, the resistance value R1 of the motor 5 is calculated by using the expression below (step S3):

V=R1·I

where V is the voltage detected by the voltage detector 11, and I is the current detected by the current detector 10.

Next, the motor 5 is rotated by an angle (for example, 5°) that is not enough to move the manipulator 2 (step S4). Thereafter, a voltage that is not enough to rotate the motor 5 is applied again to the motor 5, and the current and voltage to be supplied to the motor 5 are detected (step S5). Subsequently, by using the expression below, the resistance value R2 of the motor 5 is calculated from the current and voltage detected at this time (step S6):

V=R2·I

Then, the calculated resistance values R1 and R2 are compared (step S7), the higher resistance value is output as the resistance value R of the motor 5 (steps S8 and S9) and is stored in the storage 13 (step S10), the flag N is reset (step S11), and the process returns to step S1.

In the parameter calculator 12, when there is a change in the target rotation angle position to be entered via the operating part 3, it is determined whether or not the flag N=0 (step S12). When N=0, the current and voltage being supplied to the motor 5 are detected (step S13), the resistance value R is read out from the storage 13 (step S14), and the rotational speed constant kn is calculated by using the expression below (step S15):

V =(R+n/kn)·I

where n is the rotation angle position detected by the encoder 6.

After the rotational speed constant kn is calculated, the calculated rotational speed constant kn is stored in the storage 13 (step S16), the flag N is set to N=1 (step S17), and the process returns to step S1.

When the flag N=1 in step S12, the current and voltage being supplied to the motor 5 are detected (step S18), the rotational speed constant kn is read out from the storage 13 (step S19), and the resistance value R of the motor 5 is calculated by using the expression below (step S20). The resistance value R in the storage 13 is updated with the calculated resistance value R (step S21), and the process returns to step S1.

A method for controlling the thus-configured manipulator system 1 according to this embodiment will be described below.

In the method for controlling the manipulator system 1 according to this embodiment, when there is no change in the operation input entered by the operator via the operating part 3, the resistance value R1 of the motor 5 is calculated (step S3), and then, the motor 5 is moved slightly (step S4). Thereafter, the resistance value R2 of the motor 5 is calculated (step S5), and the higher one of the calculated resistance values R1 and R2 is stored in the storage 13 as the resistance value R (step S9).

With this configuration, even when a brushed DC motor, whose resistance value could be detected as a lower value than the true value due to the positional relationship between the brush and the commutator, is used, it is possible to calculate a resistance value that is closer to the true value. That is, leading to an advantage in that it is possible to accurately operate the motor 5, and hence, the manipulator 2.

Then, by repeating the process from step S1 to step S10 even when there is no change in the operation input entered by the operator via the operating part 3, it is possible to successively update the resistance value R and to accurately detect the resistance value R the next time the manipulator 2 is operated even when the manipulator 2 is maintained in a stopped state, and the temperature of the motor 5 is decreasing.

Furthermore, when the manipulator 2 in a stopped state is actuated for the first time, the rotational speed constant is calculated by using the latest resistance value R stored in the storage 13. Thus, it is possible to accurately update the rotational speed constant. While the manipulator 2 is operating, the resistance value is calculated and updated by using the rotational speed constant calculated in the step S15. Thus, it is possible to always control the current of the motor 5 by using the latest resistance value and the rotational speed constant.

As has been described above, with the manipulator system 1 and the method for controlling the same according to this embodiment, there are advantages in that it is possible to update the rotational speed constant kn in addition to the resistance value of the motor 5, which changes with a temperature change. Accordingly, it is possible to accurately compensate for the inductance caused by the rotation, and to accurately operate the manipulator 2.

In this embodiment, a brushed DC motor has been described as an example of the motor 5. Because a brushed DC motor has two resistance values due to the mutual positional relationship between the brush and the commutator, steps S2 to S9 for detecting an appropriate resistance value are employed. When the motor 5 is another motor, such as a brushless DC motor, these steps are unnecessary, and the resistance value R can be calculated from the current I and the voltage V that are detected at once.

In the embodiments described above, the controller 4 can be realized by hardware such as one or more Central Processing Unit (CPU), and by reading instructions stored on a computer readable storage device.

As a result, the following aspect is read from the above described embodiment of the present invention.

An aspect of the present invention is a manipulator system including: a manipulator that is driven by a motor; an operating part via which an operation input for operating the manipulator is entered; a controller that is configured to control the motor on the basis of the operation input entered via the operating part; and a position detector that is configured to detect the rotation angle position of the motor. The controller includes a current detector that is configured to detect a current to be supplied to the motor in response to the operation input, a voltage detector that is configured to detect a voltage to be supplied to the motor in response to the operation input, and a parameter calculator that is configured to calculate the resistance value and the rotational speed constant of the motor on the basis of the rotation angle position detected by the position detector, the current detected by the current detector, and the voltage detected by the voltage detector. The motor is controlled by using the resistance value and the rotational speed constant calculated by the parameter calculator. When there is no change in the operation input to be entered via the operating part, the parameter calculator outputs, among two resistance values calculated on the basis of the current detected by the current detector and the voltage detected by the voltage detector before and after the motor is moved slightly, the higher resistance value as the resistance value of the motor.

According to this aspect, when an operation input is input by operating the operating part, the controller generates a voltage instruction and a current instruction based on the operation input and supplies them to the motor. The current to be supplied to the motor is detected by the current detector, and the voltage is detected by the voltage detector. When a voltage and a current are supplied to the motor to drive the motor, the position detector provided on the manipulator detects the rotation angle position of the motor. In the controller, the parameter calculator calculates the resistance value and the rotational speed constant of the motor on the basis of the detected current, voltage, and rotation angle position. Then, the controller controls the motor using the calculated resistance value and the rotational speed constant.

Specifically, when the temperature is changed by driving the motor, not only the resistance value of the motor, but also the rotational speed constant changes. Hence, by successively calculating the rotational speed constant in addition to the resistance value and by controlling the motor using the calculated resistance value and the rotational speed constant, it is possible to compensate for parameter changes caused by a temperature change in more detail, to accurately operate the manipulator.

When there is no change in the operation input, the manipulator does not move, and the motor is maintained in a stopped state. If the stopped state of the motor continues, the heat dissipates, changing the resistance value. Hence, with this configuration in which the resistance value is calculated on the basis of the current and voltage to be supplied even when the motor is in a stopped state, it is possible to accurately operate the manipulator when the next operation input for operating the manipulator is input.

In the above-described aspect, the motor may be a brushed DC motor.

With this configuration, even when the motor is a brushed DC motor, and two types of resistance values are detected on the basis of the positional relationship between the brush and the commutator, the parameter calculator outputs a true resistance value. Hence, it is possible to accurately operate the manipulator when the next operation input for operating the manipulator is input.

In the above-described aspect, the controller may include a storage that is configured to store a parameter calculated by the parameter calculator.

Another aspect of the present invention is a method for controlling a manipulator system in which a motor for driving a manipulator is controlled on the basis of an operation input, the method including: detecting the rotation angle position of the motor; detecting a current and a voltage to be supplied to the motor in response to the operation input; calculating the rotational speed constant of the motor on the basis of the detected rotation angle position, current, and voltage, determining if there is a change in the operation input to be entered; when there is no change in the operation input, slightly moving the motor and calculating two resistance values on the basis of the current and the voltage detected before and after the motor is moved slightly; outputting the higher resistance value, among the two calculated resistance values, as the resistance value of the motor, and controlling the motor using the calculated resistance value and the rotational speed constant.

### REFERENCE SIGNS LIST

1 manipulator system

2 manipulator

3 operating part

4 controller

5 motor

6 encoder (position detector)

10 current detector

11 voltage detector

12 parameter calculator

1. A manipulator system comprising:
a manipulator configured to be driven by a motor;
an operating part configured to generate an operation input for operating the manipulator; and
a controller configured to control the motor;
wherein the controller comprises one or more processors, the one or more processors are configured to:
receive a first current of the motor;
receive a first voltage of the motor;
calculate a first resistance value of the motor on the basis of the first current and the first voltage;
control the motor so as to rotate thereof under a predetermined angle;
receive a second current of the motor after rotating the motor;
receive a second voltage of the motor after rotating the motor;
calculate a second resistance value of the motor on the basis of the second current and the second voltage;
adopt the larger one of the first resistance value and the second resistance value as a calculated resistance value; and
control the motor on the basis of the operation input and the calculated resistance value.

2. The manipulator system according to claim 1, wherein the motor is a brushed DC motor.

3. The manipulator system according to claim 1, wherein the controller further comprises a storage that is configured to store the calculated resistance value.

4. The manipulator system according to claim 3, further comprising an encoder configured to detect a rotation angle position of the motor, wherein the one or more processors further configured to:
receive a third current to be supplied to the motor in response to the operation input;
receive a third voltage to be supplied to the motor in response to the operation input;
receive the calculated resistance value from the storage;
receive the rotation angle position from the encoder;
calculate a rotational speed constant on the basis of the third current, the third voltage, the calculated resistance value and the rotation angle position; and
control the motor on the basis of the operation input, the calculated resistance value and the rotational speed constant.

5. The manipulator system according to claim 4, wherein the storage further configured to store the rotational speed constant.

6. The manipulator system according to claim 5, wherein the one or more processors further configured to:
receive a forth current to be supplied to the motor in response to the operation input;
receive a forth voltage to be supplied to the motor in response to the operation input;
receive the rotational speed constant from the storage; and
update the calculated resistance value on the basis of the forth current, the forth voltage and the rotational speed constant.

7. A controller for controlling a manipulator system including a manipulator configured to be driven by a motor, the controller comprising:
one or more processors configured to:
receive a first current of the motor;
receive a first voltage of the motor;
calculate a first resistance value of the motor on the basis of the first current and the first voltage;
control the motor so as to rotate thereof under a predetermined angle;
receive a second current of the motor after rotating the motor;
receive a second voltage of the motor after rotating the motor;
calculate a second resistance value of the motor on the basis of the second current and the second voltage;
adopt the larger one of the first resistance value and the second resistance value as a calculated resistance value; and
control the motor on the basis of the calculated resistance value.

8. The controller according to claim 7, wherein the one or more processors further configured to:
receive a third current to be supplied to the motor in response to an operation input by an operator;
receive a third voltage to be supplied to the motor in response to the operation input;
receive the calculated resistance value from a storage, the storage is configured to store the calculated resistance value;
receive the rotation angle position from an encoder, the encoder is configured to detect a rotation angle position of the motor;
calculate a rotational speed constant on the basis of the third current, the third voltage, the calculated resistance value and the rotation angle position; and
control the motor on the basis of the operation input, the calculated resistance value and the rotational speed constant.

9. The controller according to claim 8, wherein the one or more processors further configured to:
receive a forth current to be supplied to the motor in response to the operation input;
receive a forth voltage to be supplied to the motor in response to the operation input;
receive the rotational speed constant from the storage; and
update the calculated resistance value on the basis of the forth current, the forth voltage and the rotational speed constant.

10. The controller according to claim 7, wherein the motor is a brushed DC motor.

11. A non-transitory computer-readable medium storing a computer-readable program for implementing controlling method with a manipulator system including a manipulator configured to be driven by a motor, the method comprising:
receiving a first current of the motor;
receiving a first voltage of the motor;
calculating a first resistance value of the motor on the basis of the first current and the first voltage;
controlling the motor so as to rotate thereof under a predetermined angle;
receiving a second current of the motor after rotating the motor;
receiving a second voltage of the motor after rotating the motor;
calculating a second resistance value of the motor on the basis of the second current and the second voltage;
adopting the larger one of the first resistance value and the second resistance value as a calculated resistance value; and
controlling the motor on the basis of the calculated resistance value.

12. The non-transitory computer-readable medium according to claim 11, wherein the method further comprising:
receiving a third current to be supplied to the motor in response to an operation input by an operator;
receiving a third voltage to be supplied to the motor in response to the operation input;
receiving the calculated resistance value from a storage, the storage is configured to store the calculated resistance value;
receiving the rotation angle position from an encoder, the encoder is configured to detect a rotation angle position of the motor;
calculating a rotational speed constant on the basis of the third current, the third voltage, the calculated resistance value and the rotation angle position; and
controlling the motor on the basis of the operation input, the calculated resistance value and the rotational speed constant.

13. The non-transitory computer-readable medium according to claim 12, wherein the method further comprising:
receiving a forth current to be supplied to the motor in response to the operation input;
receiving a forth voltage to be supplied to the motor in response to the operation input;
receiving the rotational speed constant from the storage; and
updating the calculated resistance value on the basis of the forth current, the forth voltage and the rotational speed constant.

14. The non-transitory computer-readable medium according to claim 11, wherein the motor is a brushed DC motor.
